(19) United States
(12) Patent Application Publication
(10) Pub. No.: US 2017/0144893 A1
(43) Pub. Date: May 25, 2017

(54) DESALINATION METHOD BY HEAT AND CONDENSATION

(71) Applicant: Adrian Vazquez Torres, Madrid (ES)

(72) Inventor: Adrian Vazquez Torres, Madrid (ES)

(21) Appl. No.: 14/951,525

(22) Filed: Nov. 25, 2015

(51) Int. Cl. C02F 1/10; B01D 1/14

(52) U.S. Cl. CPC C02F 1/10; B01D 1/14; C02F 2103/08

(57) ABSTRACT

Method of desalination of water by heat and condensation so that using forced air streams on water and/or humid surfaces said air is moistened and, afterwards, is condensed, thereby obtaining desalinated water and characterized in that the method comprises three basic steps, beginning with obtaining air streams to further humidification of the air streams and evaporation of the salt water, ending with condensation of the saturated air streams, thus achieving the desalinated water precipitation that is conveniently collected.

### OBJECT OF THE INVENTION

The advocated invention relates to a method of desalination of water by heat and condensation so that using forced air streams on water and/or humid surfaces said air is moistened and, afterwards, is condensed, thereby obtaining desalinated water.

### FIELD OF THE INVENTION

The invention relates to the field of the salt water desalination industry either from sea water or brackish inland waters.

### BACKGROUND OF THE INVENTION

There are many precedents regarding water desalination.

There are procedures utilizing reverse osmosis through permeable membranes.

They have no relation to the present invention.

There are procedures utilizing in-depth pressure, as disclosed by the patent WO2015070379 titled “METHOD AND MEANS FOR DILUTION OR CONCENTRATION OF SOLUTIONS APPLIED TO WATER DESALINATION PROCEDURES”.

The procedure is performed in wells at 450 m of depth.

It also has little relation to the advocated patent.

Another method used relates to distillation, which also does not have any relation with the advocated system.

The oldest and most similar background to the advocated invention can be summarized in two patents:

Patent WO0004968, “METHOD FOR DISTILLING A FLUID WITH HORIZONTAL VAPOUR TRANSFER INTO A CONDENSATION AREA AND MODULAR DEVICE FOR IMPLEMENTING SAID METHOD”.

By distillation process of a fluid, particularly applicable, but not limited to, to the desalination of brackish and/or sea water, the type of multi-effect films dripping plates and comprising a cell with one or more evaporation areas and condensation areas, characterized in that the evaporation areas (EVAP) and the condensation areas (COND) are arranged vertically, and separated by a central longitudinal upright, the liquid to be distilled flows into the top of the evaporation area (EVAP), and drips as a thin film on the walls of a cell, the vapours produced in the evaporation area (EVAP) are transferred horizontally into the condensation area (COND) through calibrated holes on the central upright , the condensed liquid drips vertically along the condensation area walls and is evacuated through the bottom of this area

Obviously it is a different method that does not use the air streams directly, but relies instead on condensation towers.

The other reference would be the patent WO9214531, for “WATER DISTILLATION FOR DESALINATION OR PURIFICATION OF INDUSTRIAL AND AGRICULTURAL WASTEWATER”; consisting of a method and an apparatus for distilling a liquid that is near or above the critical point, wherein the liquid is fed into a separation area (32) in which a temperature profile is provided which rises from a liquid inlet hole to a steam outlet hole in a predominant part of the separation area, reaching said liquid, at said temperature profile, a temperature near or above the critical temperature of the liquid and the residue (53) is removed immediately below the liquid's surface (45) located in the separation area (32). The method and apparatus are useful for saline water desalination and for purification and thermal treatment of wastewaters from industry and agriculture.

Although this patent is closest to the advocated patent process, it does not involve water streams, heating of steam and obtaining desalinated water by condensation.

No invention disclosing the arrangement, method and advantages emerging from the inventions described below is known by the inventor.

### DESCRIPTION OF THE INVENTION

The advocated invention relates to a method of desalination of water by heat and condensation so that using forced air streams on water and/or humid surfaces said air is moistened and, afterwards, is condensed, thereby obtaining desalinated water, the method comprising three basic steps.
obtaining air streams,
humidification and evaporation of salt water
   and
condensation

Initially, the process begins with an input of unforced natural air that, by the corresponding acceleration means, such as fans, duct narrowing to take advantage of the venturi effect, or other means.

The procedure follows with the humidification and evaporation step, wherein this part of the process is performed in an open air space where air streams enter an area, the evaporation section where there is a water tank with salt water coming from the sea or from brackish wells through an upper inlet.

In this section there are means for heating the air stream flowing through the space and means for heat emission, thereby the air streams increase its absolute humidity along its path by contact with the surface of the saltwater.

At the end of the previous process, the water is in a state close to saturation.

At this point, the saturated air stream passes through a heat exchanger, which lowers its temperature below the dew point, thus achieving the condensation of non-salt water in the moisture reduction area, contiguous to the heat exchanger, collecting the non-salt water in a water tank by gravity.

The air stream can flow directly out or be reintroduced into the cycle.

### DESCRIPTION OF THE DRAWINGS For a better understanding of the invention a sheet of drawings is attached, in which the following is shown:

FIG. 1.—Schematic section view of the device for water desalination

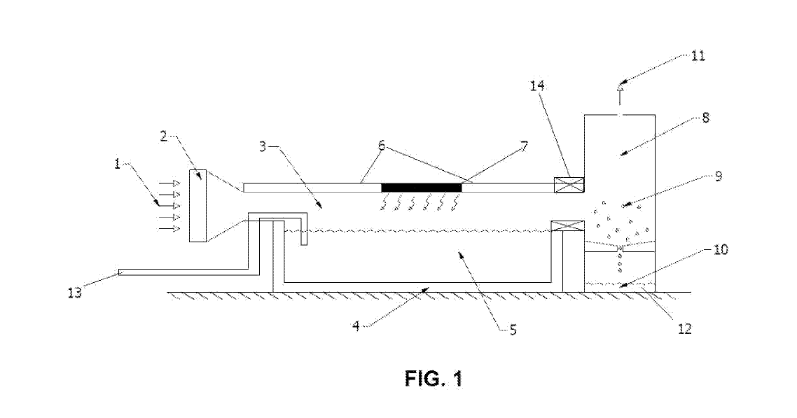

And in said figure, identical elements have the same reference, among which the following can be identified:
(1)—air inlet,
(2).—air acceleration means,
(3).—evaporation section,
(4).—salt water tank,
(5).—salt water,
(6).—heat absorption means,
(7).—heat emission means,
(8) moisture reduction area,
(9) non-salt water condensation area,
(10).—non-salt water tank,
(11).—air outlet to the outside,
(12).—non-salt water,
(13).—inlet for salt water,
(14)—heat exchanger

### PREFERRED EMBODIMENT OF THE INVENTION

The advocated invention relates to a method of desalination of water by heat and condensation by which using forced air streams on water and/or humid surfaces said air is moistened and, afterwards, is condensed, thereby obtaining desalinated water.

More particularly the method comprises three basic stages
A.—obtaining air streams,
B.—humidification and evaporation of salt water
   and
C.—condensation.

A.—Obtaining air streams.

Initially, the process begins with an input of unforced natural air (1) that, by the corresponding acceleration means (2), such as fans, duct narrowing that takes advantage of the venturi effect or other means.

B.—Humidification and evaporation.

This part of the process is performed in an open air space where air streams enter an area, the evaporation section (3), where there is a water tank (4) with salt water (5) coming from the sea or from brackish wells through an upper inlet (13).

In this section there are means for space heating (6) and heat emission means (7), so that the air streams increase its absolute humidity along its path by contact with the surface of the salt water.

C.—Condensation.

At the end of the previous process, the air is in a state close to saturation.

At this point, the saturated air stream passes through a heat exchanger (14), which lowers its temperature below the dew point, thus achieving the condensation of non-salt water (9) in the moisture reduction area (8), contiguous to the heat exchanger (14), collecting the non-salt water (12) in the non-salt water tank (10) by gravity.

The air stream can flow directly out (11) or be reintroduced into the cycle.

Having sufficiently described the nature of the invention, as well as how to be implemented, it must be stated that the provisions referred to above and shown in the accompanying drawings can be modified in details, provided they do not alter the fundamental principles set out in the above paragraphs and summarized in the following claims.

1. Method of desalination of water by heat and condensation so that using forced air streams on water and/or humid surfaces said air is moistened and, afterwards, is condensed, thereby obtaining desalinated water, and characterized in that the method comprises three basic steps
A.—obtaining air streams,
B.—humidification of the air streams and evaporation of salt water
C.—condensation of the air streams

2. The method according to claim 1, characterized in that step A begins through a non-forced inlet for natural air(1) that by the corresponding acceleration means (2), it becomes an air stream

3. The method according to claim 2 characterized in that step B is conducted in an open ended space where air streams enter an area called the evaporation section (3) where there is a water tank (4) with salt water (5) coming from the sea or from brackish wells by an upper inlet (13) and where there are means for space heating (6) and heat emission means (7), thereby the air streams increases its absolute humidity along its path by contact with the surface of the salt water

4. The method according to claim 3 characterized in that step C begins when at the end of the previous step the air is in a state near saturation and at that point the saturated air stream passes through a heat exchanger (14) which lowers its temperature below the dew point, thus achieving the condensation of non-salt water (9) in the moisture reduction area, contiguous to the heat exchanger (14), collecting the non-salt water (12) in the non-salt water tank (10) by gravity

5. The method according to claim 4 characterized in that the air stream can directly go out (11) or be reincorporated into the cycle
